(19) United States
(12) Patent Application Publication
(10) Pub. No.: US 2008/0010394 A1
(43) Pub. Date: Jan. 10, 2008

(54) Devices and methods for storing and delivering music excerpts

(76) Inventors: Adam Bell, San Francisco, CA (US); Anthony Saunders, San Francisco, CA (US)

Correspondence Address: Adam Bell, 416 Funston Avenue, San Francisco, CA, 94118, US

(21) Appl. No.: 11/481,351

(22) Filed: Jul. 5, 2006

(51) Int. Cl. G06F 12/00

(52) U.S. Cl. 711/100

(57) ABSTRACT

Devices and methods for storing and retrieving information on demand wherein the information is associated with, for example, a compact disc or digital video disc.

### BACKGROUND

The experience of buying compact discs is well known to almost everybody, as is the frustration of not being able to listen to tracks of the CD in the shop before deciding whether to make a purchase. On-line music stores such as Napster™ and Apple iTunes™ do allow the user to listen to excerpts of each track, enhancing the buying experience and making a sale more likely. Listening stations are often provided in music shops, but these listening stations require high initial investment in hardware, need to be loaded by staff and can contain only a limited number of CDs. Additionally, every CD loaded into the listening station must be opened, therefore the original packing is destroyed and the CD becomes “used” rather than new. It would be highly desirable if a shopper could listen to representative tracks or excerpts of every CD carried in a shop before purchasing and without having to open the CD or load it into a player. This invention provides such a system that is inexpensive to implement, convenient and easy to use. It provides the shopper with greater information and makes a purchase more likely.

The present invention employs the unique UPC bar codes and numbers already present and visible upon the outside of all CD cases. A further advantage of the invention is that it has certain economic and marketing advantages including the advantage of increasing sales and also encouraging cellular telephone use, which makes the present invention attractive to investment from the cellular phone industry as well as from the music recording, wholesale and retail industries.

### BRIEF DESCRIPTION

The invention encompasses devices and methods for storing and retrieving information. Particularly it encompasses systems for retrieving music excerpts associated with a compact disc by entering the UPC number of the CD into a computerized retrieval system via a mobile telephone. The invention additionally encompasses storing music excerpts on a memory means physically associated with the CD or CD case, and accessing the music via an amplifier and headphone system.

### BRIEF DESCRIPTION OF THE FIGURES

FIG. 1 shows a schematic diagram of an embodiment of the invention showing a CD case (1), a barcode (2), a user (3), a mobile phone (4), a network (5), a retrieval system (6), a memory means (7), a request for information (8), and information being retrieved (9).

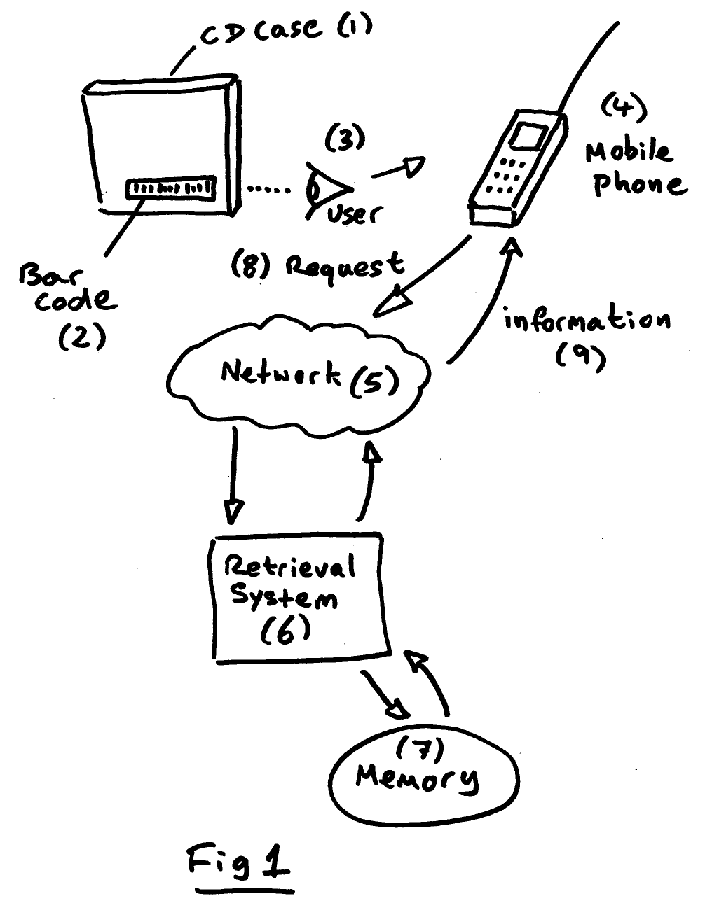

### DETAILED DESCRIPTION AND EXAMPLES

The invention encompasses devices and methods for storing and retrieving information associated with an object. Particularly it encompasses systems for storing and retrieving sound or music excerpts associated with a compact disc. In various aspects a unique identifier is applied to an object for storing music, sound or other data.

In this disclosure, the media for storing music sound or other data or the packaging in which such a media is enclosed, is generically called a “sound storage object” or sometimes simply referred to as the “object”, and may be, for example a CD or DVD or CD or DVD case or packaging or label or tag. In various embodiments, the sound storage object may be a music storage medium such as a CD, DVD, phonograph record, cassette, a flash memory card with sound (e.g. in MP3 format) encoded onto it, or any other physical digital or analogue storage medium or also may be the packaging or tag or label or other object associated with the medium. The sound storage object may be, for example, a case or container or packaging, label or tag containing or physically associated with the music storage medium, such as a CD case.

The information associated with the unique identifier is used to retrieve a music track or excerpt from a memory storage means (hereinafter referred to as a memory means) at a remote site. In an alternative embodiment, the memory means may be physically associated with or applied to the sound storage object, or in other embodiments, it may be remote from the sound storage object.

The music may be delivered from the memory means via any electronic means, either wired or wireless, for example, by wireless radio or microwave communication, for instance via a mobile telephone (cell phone) connection.

In one example, the identifier is a series of numbers, characters, letters or symbols or combination thereof, for example, the Universal Product Code (UPC) number or bar code which is invariably attached to and visible upon goods such as CDs.

This unique identifier information or part thereof may be entered into a computerized retrieval system via any communications device or system such as a mobile telephone communicating over a network of any kind including the internet. For example, an “800” number may be dialled, and a prompt would ask for the UPC number or some part thereof or for a combination of identifier information and other information such as the artist's name etc. The user would then enter at least some part of the unique identifier information and any other information required. This could be done by keying in the information, or using voice recognition software or using voice prompts. Predictive text or voice software may be used so that once a certain amount of information has been entered, the user is hen given a number of choices that closely match the information given. In other embodiments, a scanner system could be used and the data could be scanned into the communications device. The computerized retrieval system would then deliver the sound, data or music (e.g. music excerpt(s)) associated with the identifier to the user via the telephone. The excerpt could be downloaded or simply delivered to the telephone in real time in the same way as any other digital or analogue signal is delivered. The music excerpts thus accessed may include, for example, one or more 10 to 60 second excerpts of music representative of the music on the CD (e.g., at least 20 s, 30 s, 60 s, 90 s, 120 s, 180 s of music).

In an alternative embodiment, the sound storage object, such as the CD case, has within it or on it a memory means sufficient to store a desired amount of information, for example, sufficient to store a several 10 to 60 second excerpts of music representative of the music on the CD. The memory means may be, for example, a flash memory or static RAM chip memory means or a 2-dimensional bar code or any means for storing digital or analogue information. The memory means, such as a flash memory, has functionally associated with it an output port or interface that is used to interface with an external listening device (player).

The external listening device may include an integral amplification means (“amplifier”, “amplification device”), or the amplification means may be provided separately between the memory means and the listening device or may be physically integrated into the object (CD case) itself. An amplification means consists of any suitable and common amplification circuit (amplifier). Alternatively, the amplification means may be physically associated with the memory means and provided on the object (i.e., part of the CD case system).

If the amplifications means is associated with the object (e.g., CD case) itself, then a power source must also be provided, either associated with the sound storage object, such as a battery, or from an external source such as a traditional power source, photovoltaic cell etc.

The external listening device may be, for example, a mobile phone with an audio input port, an MP3 player or iPOD™ or any other digital music player with an audio input port. The audio input port may be wired or wireless, for example it could communicate via infrared, microwave or radio frequency communication, for example it could communicate by short range radio communication such as Bluetooth™ or from a cell phone transmitter tower. Wired audio input ports may include the interface provided on an iPOD™ or may be a universal serial bus (USB) port, series port, parallel port or simple round-jack audio input port similar that commonly used in audio equipment for connecting headphones and microphones to a player output port. In the case of a digital music player, amplification is provided by the player itself. In the case of an MP3 player such as an iPOD™ the player possesses an audio input port which also provides a power source (power output).

A connector is used to link the audio input port (and optionally the power output) of the MP3 player to the audio output port of the sound storage object (CD case). The connector will be of a suitable type that allows communication between the output port and the external listening device and may include a first end and a second end having one or more different connectors, such as USB connectors, Firewire connectors, coaxial connectors, multiple pin connectors, Apple Macintosh type connectors or any other known or generic connector that will provide a connection between the output and listening device. The connector may also act as a power conduit, transferring power from the listening device to the CD case device memory means as necessary. Once a link is established between the MP3 player and the audio output port of the CD case, power is provided to the memory means and information is conveyed via the connector to the player.

In another embodiment wherein the memory means is physically associated with the sound storage object (e.g., CD case), the system additionally includes an amplification device communicably attached to the memory means, and an output jack, and a power source to power the amplifier, allowing a user to listen to a track by plugging headphones directly into the output of the CD case itself.

In an alternative embodiment, the memory means is physically associated with the sound storage object (e.g., CD case), and the system additionally includes an amplification device communicably attached to the memory means, and a power source to power the amplifier, and a speaker, providing a totally self-contained system allowing a user to listen to a track directly from the CD case itself. The resonating board of the speaker may be provided in part by the polymer CD case itself.

In various embodiments, the system further comprises a control interface used to control the playing of music excerpts, including, for example, “play” “pause” “stop” “rewind” and “fast forward” buttons. The control interface may be integrated into the sound storage object (CD case) device and may comprise standard pressure-sensitive switch buttons. It will preferably be in functional communication with the memory means and the amplification means. The control buttons of the control interface will be in functional communication with at least one integrated circuit (IC) or microprocessor or central processing unit (CPU) which will receive information from components (such as the control buttons), process information, and send information to other components (such as the memory means and amplifier) to control the device and provide functionality.

The invention may comprise a device with one or more lights or other indicators to indicate the status of various functions of the device, such as to indicate that the device is on, playing or is outputting sound at a particular volume etc. Such status indicators will be in functional communication with the CPU and or other components of the device. Such status indicators will commonly be LEDs.

Specifically, the invention encompasses a system and method for storing and delivering information, the method comprising:
providing a unique identifier associated with an object
providing a memory means located remotely from the object and wherein the memory means is uploaded with information associated with a number of objects
providing a computerized retrieval system functionally associated with the memory means that can be controlled remotely
providing a communications device (e.g., a mobile phone)
communicating between (establishing a communications link between) the communications device and the computerized retrieval system
entering the unique identifier (or some part thereof) via the communications device into the computerized retrieval system such that the computerized retrieval system is instructed to deliver information associated with the unique identifier to the user
thereby accessing the information associated with the object

In another specific embodiment, the invention encompasses a system and method specifically for storing and delivering sound information (such as music, or speech), the method comprising:
providing a unique identifier associated with an object (e.g., a sound storage object such as a CD or CD case or any physical medium)
providing a memory means (e.g., flash memory, static RAM chip, tape memory, hard-disc, CD, DVD, or any medium capable of storing information such as on a computer server) located remotely from the object, and wherein the memory means is uploaded with sound information (in another embodiment, memory is in or on CD case or packaging itself)
providing a computerized retrieval system functionally associated with the memory means that can be controlled remotely (e.g., by commands transferred via a signal from a telephone)
providing a communications device (e.g., a mobile phone)
communicating between (establishing a communications link between) the communications device and the computerized retrieval system
entering the unique identifier (or some part thereof) via the communications device into the computerized retrieval such that the computerized retrieval system is instructed to deliver information (music) to the user
thereby accessing the sound information (e.g., music excerpt) associated with the object.

In another embodiment, the invention encompasses a system and method for storing and delivering digitized information (music excerpts, voice, data etc) directly from a memory means physically associated with a physical object, the method comprising:
providing a memory means in or on or otherwise physically associated with the object (e.g., CD case, packaging etc) wherein the memory means stores (is uploaded with) digitized information
providing a communications port/interface physically and functionally associated with and in communication with the memory means
providing an external listening device (player, cell phone, system comprising amplifier and speaker etc) for accessing, amplifying and listening to the stored digitized information (e.g., an iPod or phone or computer with audio input)
providing a connector connecting the player and memory means thereby linking the communications port with listening device
listening to music

In another embodiment, the invention encompasses a system and method specifically for storing and delivering sound information (music excerpts, voice etc), the method comprising:
providing a memory means in or on the object (CD case) uploaded with music
providing an amplification device integrally physically associated with the object and functionally associated and in communication with the memory means providing an audio output
providing a speaker external to the system (such as headphones)
connecting audio output port to the headphones
listening to music

In another embodiment, the invention encompasses a system and method for storing and delivering digitized information (music excerpts) using speakers physically associated with the object (i.e., allowing the listener to listen directly to the music from the CD packaging), the method comprising:
providing a memory means in or on the object (CD case) uploaded with music
providing an amplification device integrally physically associated with the object and functionally associated and in communication with the memory means
providing a power source (e.g., battery) to power the amplification device
providing a speaker internal to the system (physically associated with the amplification device and built into or onto the CD case or packaging) functionally connected to the amplifier
providing a control interface allowing a user to initiate playing of the music etc
listening to the music

In another example, the information, such as music, may actually be stored in a bar-code itself. Bar codes, particularly two-dimensional ones (that contain information in both the vertical and horizontal directions) can store a sizeable amount of information. Below is a table showing different types of standard bar code and the amount of information that can be stored in each.

| | QR Code | PDF417 | DataMatrix | Maxi Code |
|---|---|---|---|---|
| | [symbol] | [symbol] | [symbol] | [symbol] |
| Developer(country) | DENSO(Japan) | Symbol | RVSI Acuity | UPS (USA) |
| | | Technologies | CiMatrix | |
| | | (USA) | (USA) | |
| Type | Matrix | Stacked Bar Code | Matrix | Matrix |
| Numeric | 7,089 | 2,710 | 3,116 | 138 |
| Data capacity | | | | |
| Alphanumeric | 4,296 | 1,850 | 2,355 | 93 |
| Binary | 2,953 | 1,018 | 1,556 | |
| Kanji | 1,817 | 554 | 778 | |
| Main features | Large capacity, | Large capacity | Small printout | High speed scan |
| | small printout size | | size | |
| | High speed scan | | | |
| Main usages | All categories | OA | FA | Logistics |
| Standardization | AIM International | AIM | AIM | AIM |
| | JIS | International | International | International |
| | ISO | ISO | ISO | ISO |

The bar code may be applied to the sound storage object and read by means of a reader functionally linked to a computer which computer is functionally linked to a player system to allow retrieving and listening to the data or sound encoded in the bar code. The 2-D barcode has all the information stored within so there is no need to connect to a database. Because of the relatively low storage capacity of bar-code technology, music data may be limited and may be provided in a digitized compressed format. None the less, a bar code could provide sufficient storage capacity to store several seconds or more (e.g., at least 10 s, 30 s, 60 s, 120 s, 180 s) of reasonable quality sound or music. Prof. Joseph Rosen Ben Gurion University of the Negev has produces a barcode system that stores up to about 3 kilobytes of information; certainly sufficient for the current invention.

In another embodiment, the memory storage means may be an RFID chip. Newer 13.65 MHz RFID chips can store about 2000 bits of data or more. Again, this storage capacity is sufficient for the current invention.

It should be noted that although specific examples are used throughout this description, most notably music CD's and music excerpts associated with them, the invention may equally be applied to any type of media containing any kind of data, such as spoken word, or encoded computer programmes or scripts. The data delivered need not be in the form of sound (music or speech), but may be transmitted as text, for example to a cell phone or computer as a text message or instant message or picture or pictogram or any other written, symbolic or visual information.

It will be readily appreciated that various adaptations and modifications of the described embodiments can be made without departing from the scope and spirit of the invention and the above description is intended to be illustrative, not restrictive, and it is understood that the applicant claims the full scope of any claims and all equivalents.

1. A system for storing and delivering digitized information, the system comprising:
a unique identifier associated with a sound storage object,
a memory means located remotely from the sound storage object wherein the memory means has digitized information stored within it,
a computerized information retrieval system that is in functional communication with the memory means and that may be placed in communication with a communications device,
a communications device that may be placed in communication with the computerized information retrieval system,
wherein at least some information associated with the unique identifier may be entered into the communications device and communicated to the computerized information retrieval system, thereby directing the computerized information retrieval system to access the digitized information stored in the memory means, and further directing the computerized information retrieval system transmit that information to the communications device.

2. The system of claim 1 wherein the digitized information is sound information.

3. The system of claim 1 wherein the unique identifier comprises a bar code or series of characters physically associated with the sound storage object.

4. The system of claim 1 wherein the sound storage object comprises packaging material, a label or a tag applied to optical storage media.

5. The system of claim 1 wherein the communications device is a mobile telephone.

6. A method for storing and delivering digitized information, the method comprising:
providing a unique identifier associated with a sound storage object,
providing a memory means located remotely from the sound storage object wherein the memory means has digitized information stored within it,
providing a computerized information retrieval system that is functional communication with the memory means and that may be placed in communication with a communications device,
providing a communications device that may be placed in communication with the computerized information retrieval system,
entering at least some information associated with the unique identifier into communications device and communicating that information to the computerized information retrieval system, thereby directing the computerized information retrieval system to access digitized information stored in the memory means, and transmit that information to the communications device.

7. The method of claim 6 wherein the digitized information is sound information.

8. The method of claim 6 wherein the unique identifier comprises a bar code or series of characters physically associated with the sound storage object.

9. The method of claim 6 wherein the sound storage object comprises packaging material, a label or a tag applied to optical storage media.

10. A method for storing digitized information in physical association with a sound storage object and delivering the information, the method comprising:
providing a memory means in physical association with a sound storage object wherein the memory means has digitized information stored within it,
providing a communications port or interface functionally in communication with the memory means,
providing a listening device for accessing the digitized information and amplifying it
linking the communications port with listening device
accessing and delivering the digitized information.

11. The method of claim 10 wherein the digitized information is sound information.

12. The method of claim 10 wherein the unique identifier comprises a bar code or series of characters physically associated with the sound storage object.

13. The method of claim 10 wherein the memory means is selected from the group consisting of: a static RAM chip, a bar code, a two-dimensional bar code, and an RFID chip.
